(19) United States
(12) Patent Application Publication
(10) Pub. No.: US 2010/0087174 A1
(43) Pub. Date: Apr. 8, 2010

(54) CALL DISPLAY METHOD UTILIZED IN A COMMUNICATIONS SYSTEM

(76) Inventor: Biao Lu, Nanjing (CN)

Correspondence Address: NORTH AMERICA INTELLECTUAL PROPERTY CORPORATION, P.O. BOX 506, MERRIFIELD, VA, 22116, US

(21) Appl. No.: 12/573,147

(22) Filed: Oct. 4, 2009

(30) Foreign Application Priority Data
Oct. 7, 2008 (TW) 097138556

(51) Int. Cl. H04M 3/42; H04W 4/12

(52) U.S. Cl. 455/412.2; 455/415

(57) ABSTRACT

When a caller communications device receives a calling instruction from an input unit of a caller communications device, the image capturing unit takes an instant picture. The caller communications device then sends the instant picture and calling data to a communications server. Afterwards, the communications server sets up a communication link with a receiver communications device according to the calling data so as to forward the instant picture to the receiver communications device. Then the instant picture is displayed on a display of the receiver communications device. After the communications server receives a confirmation instruction from the receiver communications device, a communication link is established between the caller communications device and the receiver communications device.

### BACKGROUND OF THE INVENTION

1. Field of the Invention

The present invention relates to a call display method, and more particularly, a method which enables a caller communications device to take an instant picture of the caller as soon as a calling instruction is issued to the caller communications device, and the instant picture is sent to a receiver communications device through a communications server so that the receiver can identify the identity of the caller according to the instant picture.

2. Description of the Prior Art

In recent years, technology has experienced a period of vital growth, same as communications products. With this trend, communications devices have made a great breakthrough, not just limited to a simple communication function. Many conventional communications devices are equipped with various audio and video functions such as playing music, playing video, taking pictures, recording films, browsing web pages, etc. Moreover, they are becoming more compact and getting cheaper. Thus they are widely used in our daily lives and becoming important and convenient instruments.

For a receiver to identify the identity of a caller, communications devices are equipped with a call display function. Thus after the caller inputs a calling instruction, the caller communications device will send calling data such as the telephone number of the caller communications device and the telephone number of the receiver communications device to a communications server, then the communications server will send an incoming call message to the receiver communications device according to the calling data. When the receiver communications device receives the incoming call message, the telephone number of the caller communications device will be displayed on the receiver communications device. Thus the receiver can identify the identity of the caller according to the telephone number of the caller communications device and determine if the phone call should be answered.

However, if the identity of the caller is identified through the telephone number of the caller communications device, the receiver has to memorize many telephone numbers so as to correctly identify the identities of the callers. Thus, a common communications device is equipped with a telephone book function, so its user can store telephone book data in the memory unit of the communications device. The telephone book data includes many telephone numbers and their corresponding annotations which may be names, nicknames and pictures. Thus when the receiver communications device receives the incoming call message, the receiver communications device can search the telephone book data for the annotation corresponding to the caller communications device and display the corresponding annotation on the receiver communications device, enabling the receiver to identify the identity of the caller according to the annotation easily.

As mentioned above, if the receiver wants to identify the identity of the caller through the annotations of the telephone book data, the receiver has to store the telephone number of the caller communications device and its corresponding annotation in the memory unit of the receiver communications device beforehand, then the receiver communications device is able to display the annotation corresponding to the telephone number of the caller communications device.

However, the price of communications devices keeps moving downward, and different telecommunication companies are offering different discounts to their users. Thus many users may replace their communications devices, their service providers, and subsequently their telephone numbers frequently, resulting in that the phonebook of a receiver communications device has to be updated frequently. Otherwise, the receiver communications device would not be able to identify the identity of the caller when receiving an incoming call.

### SUMMARY OF THE INVENTION

According to an embodiment of the present invention, a call display method utilized in a communications system is disclosed. The communications system comprises a caller communications device, a communications server, and a receiver communications device. The caller communications device comprises an input unit and an image capturing unit. When the caller communications device receives a calling instruction from the input unit of the caller communications device, the image capturing unit takes an instant picture. The caller communications device then sends the instant picture and calling data to the communications server. Afterwards, the communications server sets up a communication link with the receiver communications device according to the calling data so as to forward the instant picture to the receiver communications device. Then the instant picture is displayed on a display of the receiver communications device. After the communications server receives a confirmation instruction from the receiver communications device, a communication link is established between the caller communications device and the receiver communications device.

According to another embodiment of the present invention, a call display method utilized in a communications system is disclosed. The communications system comprises a caller communications device, a communications server, and a receiver communications device. The caller communications device comprises an input unit and an image capturing unit. When the caller communications device receives a calling instruction from the input unit of the caller communications device, the image capturing unit records an instant film. The caller communications device then sends the instant film and calling data to the communications server. Afterwards, the communications server sets up a communication link with the receiver communications device according to the calling data so as to forward the instant film to the receiver communications device. Then the instant film is played on a display of the receiver communications device. After the communications server receives a confirmation instruction from the receiver communications device, a communication link is established between the caller communications device and the receiver communications device.

According to another embodiment of the present invention, a call display method utilized in a communications system is disclosed. The communications system comprises a caller communications device, a communications server, and a receiver communications device. The caller communications device comprises an input unit, an image capturing unit, and a recording unit. When the caller communications device receives a calling instruction from the input unit of the caller communications device, the image capturing unit and recording unit record an instant audio and video message. The caller communications device then sends the instant audio and video message and calling data to the communications server. Afterwards, the communications server sets up a communication link with the receiver communications device according to the calling data so as to forward the instant audio and video message to the receiver communications device. Then the instant audio and video message is played through a display and speaker of the receiver communications device. After the communications server receives a confirmation instruction from the receiver communications device, a communication link is established between the caller communications device and the receiver communications device.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram of a communications system 1 according to the present invention.

FIG. 2 is a flowchart of the call display method according to a first embodiment of the present invention.

FIG. 3 is a flowchart of the call display method according to a second embodiment of the present invention.

FIG. 4 is a flowchart of the call display method according to a third embodiment of the present invention.

### DETAILED DESCRIPTION

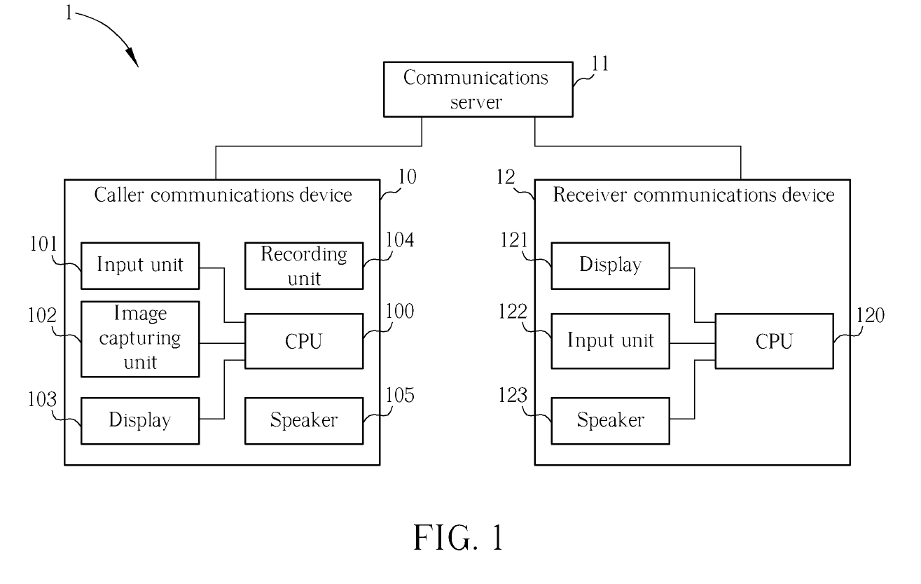

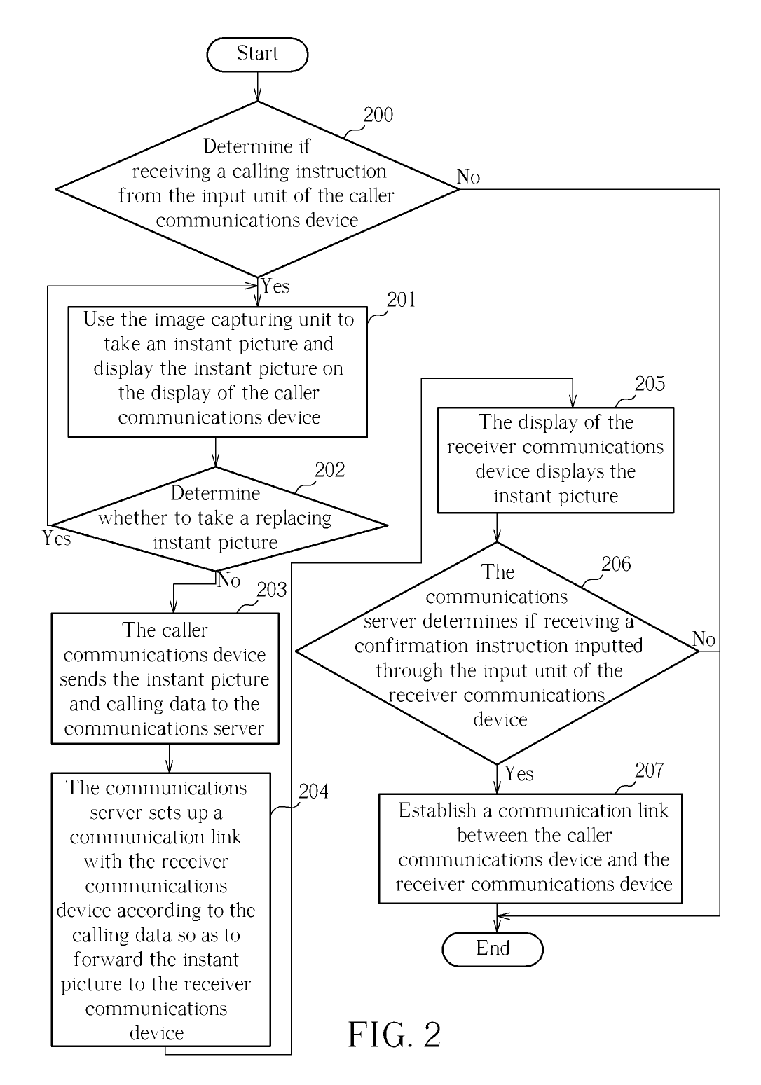

The present invention provides a call display method of a communications device. Please refer to FIG. 1. FIG. 1 is a block diagram of a communications system 1 according to the present invention. The communications system 1 comprises a caller communications device 10, a communications server 11, and a receiver communications device 12. The caller communications device 10 comprises a central processing unit (CPU) 100, an input unit 101, an image capturing unit 102, a display 103, a recording unit 104 and a speaker 105. The CPU 100 is coupled to the input unit 101, image capturing unit 102, display 103, recording unit 104 and speaker 105. The receiver communications device 12 comprises a display 121, an input unit 122, a speaker 123 and a CPU 120 coupled to the display 121, input unit 122 and speaker 123. Please refer to FIG. 2. FIG. 2 is a flowchart of the call display method according to an embodiment of the present invention. The call display method comprises the following steps:

Step 200: Determine if the caller communications device 10 has received a calling instruction from the input unit 101 of the caller communications device 10; if so, go to step 201; else, end;

Step 201: When the caller issues a calling instruction through the input unit 101 of the caller communications device 10 such as depressing a connect button, the image capturing unit 102 takes an instant picture such as the picture of the caller, and the instant picture is displayed on the display 103 for the caller to validate the instant picture;

Step 202: Determine if the caller issues a command through the input unit 101 to take a replacing instant picture; if so, go to step 201; else, go to step 203;

Step 203: The caller communications device 10 sends the instant picture and calling data such as the telephone number of the caller communications device 10 and the telephone number of the receiver communications device 12 to the communications server 11;

Step 204: The communications server 11 sets up a communication link with the receiver communications device 12 according to the calling data so as to forward the instant picture to the receiver communications device 12;

Step 205: After the communications server 11 forwards the instant picture to the receiver communications device 12, the communications server 11 terminates the communication link, and the display 121 of the receiver communications device 12 displays the instant picture so that the receiver can identify the identity of the caller through the instant picture;

Step 206: The communications server 11 determines if a confirmation instruction inputted through the input unit 122 of the receiver communications device 12 is received from the receiver communications device 12; if so, go to step 207; else, end; and

Step 207: After the communications server 11 receives the confirmation instruction from the receiver communications device 12, a communication link is established between the caller communications device 10 and the receiver communications device 12 so that the caller and the receiver can start a conversation. The communication link can be established by the communications server 11 or other means.

With this method, when the caller replaces his or her communications device or updates a telephone number, even if the phonebook of the receiver communications device is not updated, the receiver is still able to identify the identity of the caller through the instant picture, thereby avoiding being harassed by telemarketing calls, fraud calls, prank calls, etc. Through the background of the instant picture taken by the caller communications device 10, the receiver can identify the location of the caller. For example, by requesting a child to make routine phone calls, parents can track the location of their child by viewing the instant pictures the child's communications device sent to them, thereby safeguarding the safety of the child. Thus this invention greatly enhances the functionality of a communications device.

Moreover, after the image capturing unit 102 takes an instant picture, the caller communications device 10 can display the instant picture on the display 103 so that the caller can check if the instant picture is taken successfully. If the instant picture is not taken successfully, the caller can use the image capturing unit 102 to take another instant picture until a satisfactory instant picture is taken. Thus, the quality of the instant picture sent to the receiver communications device 12 can be assured and the identity of the caller can be correctly identified through the instant picture. This can prevent the caller from sending a poor instant picture to the receiver due to noise in the instant picture, failing to catch the caller's face or insufficient exposure of light, thereby causing the receiver unable to identify the identity of the caller and consequently rejecting the phone call. The above illustration is simply an embodiment of the present invention. The implementation of the present invention is not limited to the above embodiment.

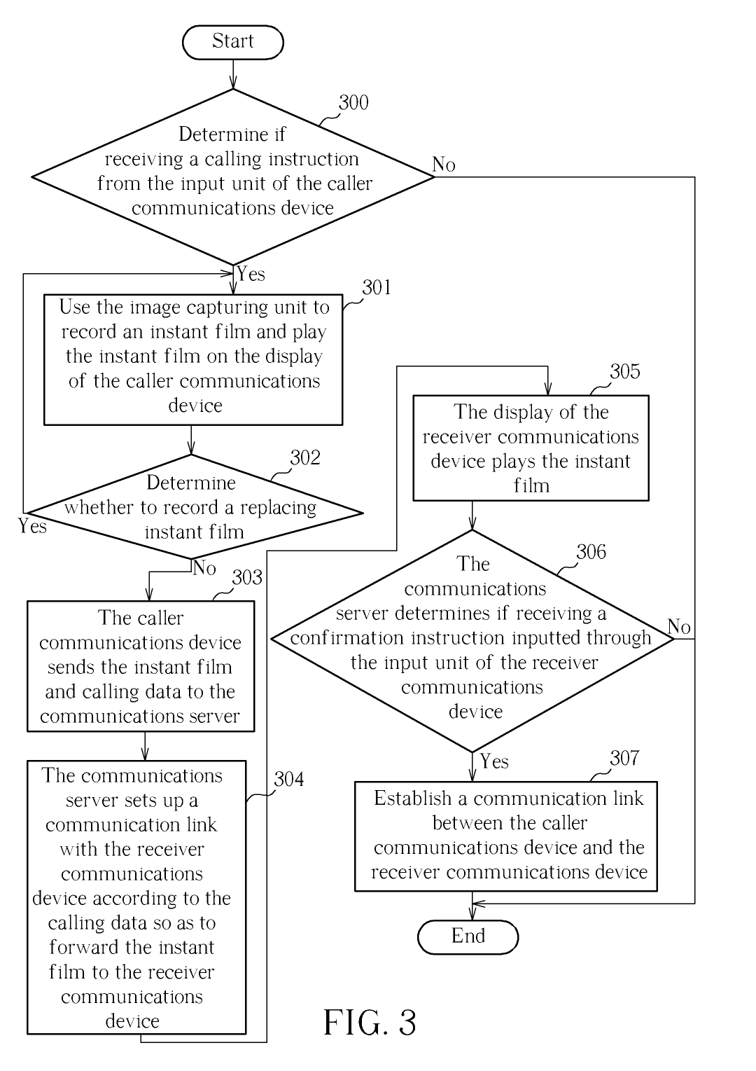

The method is not limited to using the image capturing unit 102 to take an instant picture. In a second embodiment of the present invention, as shown in FIGS. 1 and 3, the image capturing unit 102 is used to record an instant film indicated in Step 301. Thus through the instant film, the receiver can not only identify the identity of the caller, but can also identify the location of the caller through the background of the instant film. Thus the receiver can effectively verify the genuineness of the call display through the instant film, preventing a fraudster from stealing a caller's picture to forge an instant picture of the caller.

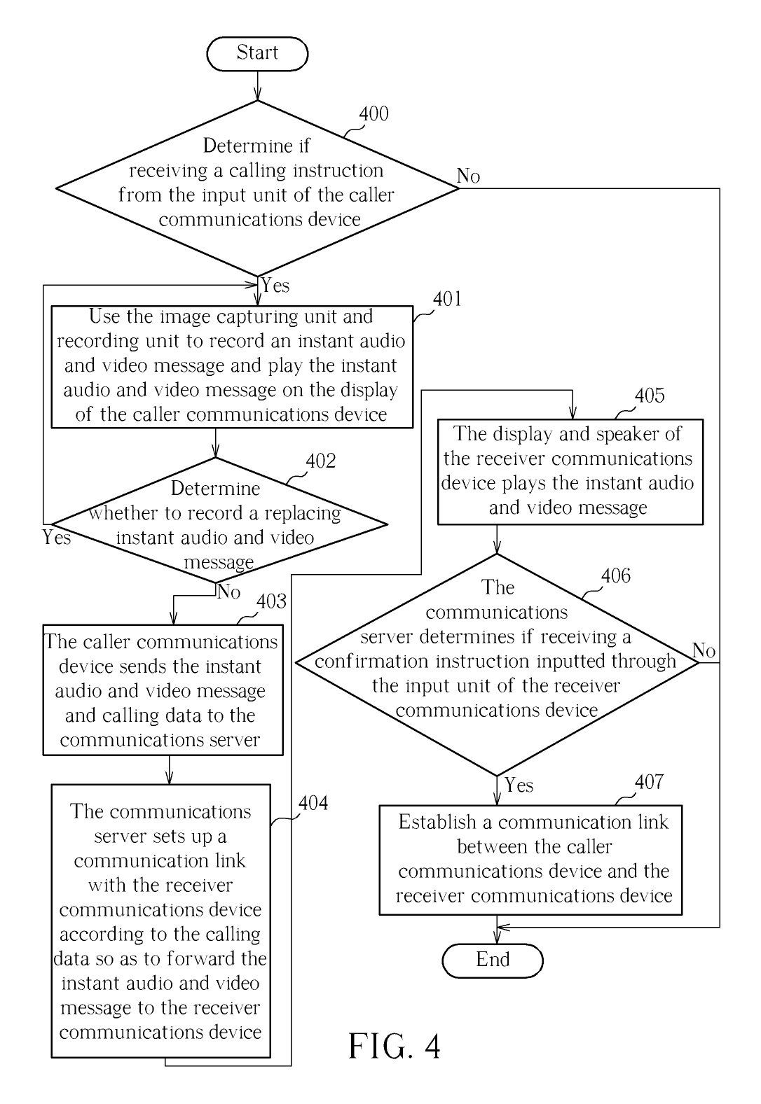

Further, in a third embodiment of the present invention, as shown in FIG. 1, the recording unit 104 and speaker 105 are coupled to the CPU 100. Please refer to FIG. 4. The communications system 1 can perform the following steps through the caller communications device 10:

Step 400: Determine if the caller communications device 10 has received the calling instruction from the input unit 101 of the caller communications device 10; if so, go to step 401; else, end;

Step 401: When the caller issues a calling instruction through the input unit 101 of the caller communications device 10 such as depressing a connect button, the image capturing unit 102 and the recording unit 104 record an instant audio and video message such as a brief self introduction of the caller, and the instant audio and video message is played through the display 103 and speaker 105 for the caller to validate the instant audio and video message;

Step 402: Determine if the caller issues a command through the input unit 101 to record a replacing instant audio and video message; if so, go to step 401; else, go to step 403;

Step 403: The caller communications device 10 sends the instant audio and video message and calling data such as the telephone number of the caller communications device 10 and the telephone number of the receiver communications device 12 to the communications server 11;

Step 404: The communications server 11 sets up a communication link with the receiver communications device 12 according to the calling data so as to forward the instant audio and video message to the receiver communications device 12;

Step 405: After the communications server 11 forwards the instant audio and video message to the receiver communications device 12, the communications server 11 terminates the communication link, and the display 121 and speaker 123 of the receiver communications device 12 plays the instant audio and video message so that the receiver can identify the identity of the caller through the instant audio and video message;

Step 406: The communications server 11 determines if a confirmation instruction inputted through the input unit 122 of the receiver communications device 12 is received from the receiver communications device 12; if so, go to step 407; else, end; and

Step 407: After the communications server 11 receives the confirmation instruction from the receiver communications device 12, a communication link is established between the caller communications device 10 and the receiver communications device 12 so that the caller and the receiver can start a conversation. The communication link can be established by the communications server 11 or other means.

With this method, when the caller replaces his or her communications device or updates a telephone number, even if the phonebook of the receiver communications device is not updated, the receiver is still able to identify the identity and location of the caller through the instant audio and video message, thereby avoiding being harassed by telemarketing calls, fraud calls, prank calls, etc.

Moreover, after the image capturing unit 102 and the recording unit 104 record an instant audio and video message, the caller communications device 10 can play the instant audio and video message through the display 103 and speaker 105 so that the caller can check if the instant audio and video message is recorded successfully. If the instant audio and video message is not recorded successfully, the caller can use the image capturing unit 102 and recording unit 104 to record another instant audio and video message until a satisfactory instant audio and video message is recorded. Thus, the quality of the instant audio and video message sent to the receiver communications device 12 can be assured and the identity of the caller can be correctly verified through the instant audio and video message. This can prevent the caller from sending a poor instant audio and video message to the receiver due to noise in the instant picture, failing to catch the caller's face or insufficient exposure of light, thereby causing the receiver unable to identify the identity of the caller and consequently rejecting the phone call.

Further, to simplify the process of the embodiments, the portions regarding displaying the instant picture, playing the instant film and playing the instant audio and video message through the display 103 and speaker 105 in Steps 201, 301 and 401 of FIGS. 2, 3 and 4 can be omitted. Steps 202, 302 and 402 can also be omitted. In this case, after the image capturing unit 102 and the recording unit 104 take an instant picture, record an instant film, or record an instant audio and video message, Steps 203, 303 or 403 can be performed to send the instant picture, instant film, or instant audio and video message to the communications server 11, thereby enhancing the efficiency of the embodiments.

In summary, the present invention can implement the following functions and effects:
1. After the caller replaces his or her communications device or updates a telephone number, even if the phonebook of the receiver communications device is not updated, the receiver is still able to identify the identity of the caller through the instant picture, instant film, or instant audio and video message; and
2. The quality of the instant picture, instant film, or instant audio and video message sent to the receiver communications device 12 can be assured, and the identity of the caller can be correctly identified through the instant picture, instant film, or instant audio and video message.

Those skilled in the art will readily observe that numerous modifications and alterations of the device and method may be made while retaining the teachings of the invention.

What is claimed is:

1. A call display method utilized in a communications system, the communications system comprising a caller communications device, a communications server, and a receiver communications device, the caller communications device comprising an input unit and an image capturing unit, the method comprising:
when the caller communications device receives a calling instruction from the input unit of the caller communications device, using the image capturing unit to take an instant picture;
the caller communications device sending the instant picture and calling data to the communications server;
the communications server setting up a communication link with the receiver communications device according to the calling data so as to forward the instant picture to the receiver communications device;
displaying the instant picture on a display of the receiver communications device; and
after the communications server receives a confirmation instruction from the receiver communications device, establishing a communication link between the caller communications device and the receiver communications device.

2. The call display method of claim 1, wherein the caller communications device further comprises a display, and the method further comprises displaying the instant picture on the display of the caller communications device for determining whether to take a replacing instant picture.

3. A call display method utilized in a communications system, the communications system comprising a caller communications device, a communications server, and a receiver communications device, the caller communications device comprising an input unit and an image capturing unit, the method comprising:
when the caller communications device receives a calling instruction from the input unit of the caller communications device, using the image capturing unit to record an instant film;
the caller communications device sending the instant film and calling data to the communications server;
the communications server setting up a communication link with the receiver communications device according to the calling data so as to forward the instant film to the receiver communications device;
playing the instant film on a display of the receiver communications device; and
after the communications server receives a confirmation instruction from the receiver communications device, establishing a communication link between the caller communications device and the receiver communications device.

4. The call display method of claim 3, wherein the caller communications device further comprises a display, and the method further comprises playing the instant film on the display of the caller communications device for determining whether to record a replacing instant film.

5. A call display method utilized in a communications system, the communications system comprising a caller communications device, a communications server, and a receiver communications device, the caller communications device comprising an input unit, an image capturing unit, and a recording unit, the method comprising:
when the caller communications device receives a calling instruction from the input unit of the caller communications device, using the image capturing unit and the recording unit to record an instant audio and video message;
the caller communications device sending the instant audio and video message and calling data to the communications server;
the communications server setting up a communication link with the receiver communications device according to the calling data so as to forward the instant audio and video message to the receiver communications device;
playing the instant audio and video message through a display and a speaker of the receiver communications device; and
after the communications server receives a confirmation instruction from the receiver communications device, establishing a communication link between the caller communications device and the receiver communications device.

6. The call display method of claim 5, wherein the caller communications device further comprises a display and a speaker, and the method further comprises playing the instant audio and video message through the display and speaker of the caller communications device for determining whether to record a replacing instant audio and video message.
